(19) United States
(12) Patent Application Publication
(10) Pub. No.: US 2014/0358645 A1
(43) Pub. Date: Dec. 4, 2014

(54) ASSET MANAGEMENT KEY PERFORMANCE INDICATORS AND BENCHMARKING

(71) Applicant: I.D. Systems, Inc., Woodcliff Lake, NJ (US)

(72) Inventors: Ken Ehrman, Upper Saddle River, NJ (US); Michael Ehrman, Upper Saddle River, NJ (US); Jeffrey Jagid, Demarest, NJ (US); Darren McGurran, Quincy, MA (US)

(73) Assignee: I.D. SYSTEMS, INC., Woodcliff Lake, NJ (US)

(21) Appl. No.: 13/905,601

(22) Filed: May 30, 2013

(51) Int. Cl. G06Q 10/06

(52) U.S. Cl. CPC G06Q 10/06393
USPC 705/7.39

(57) ABSTRACT

Monitoring asset performance to identify key performance indicators (KPIs) is described. A method is described including receiving a set of asset performance information relating to at least one target asset associated with a company, calculating a KPI in view of the set of asset performance information, determining a cost benefit measurement based on the calculated KPI, and generating a report including at least one of the KPI or the cost benefit measurement. Additionally, the calculated KPIs and/or cost benefit measurements may be used to perform intra-company comparisons and inter-company comparisons.

### TECHNICAL FIELD

Embodiments of the present disclosure relate to the field of asset management and, more particularly, to tracking and monitoring key performance indicators associated with a fleet of vehicles.

### BACKGROUND

A collection of assets (e.g., a fleet of vehicles, such as forklifts, containers, chassis, etc.) may be monitored by an asset management system to identify operational issues concerning the assets. The asset management system may collect data associated with the monitored assets using, for example, a communications system including devices associated with the individual assets. The collected data may be used to provide an owner, manager and/or operator of the assets with information relating to the operation and status of the assets (e.g., to identify whether an asset is functioning properly, being used efficiently, and/or requires service), without the context of the how a particular customer or facility compares to other similar customers in the industry.

Furthermore, conventional asset management systems fail to track indicators or metrics which provide the basis for site-to-site and industry comparisons and benchmarking to enable a customer to understand and assess how their assets are performing relative to their peers and quantify a return on investment associated with their assets. Moreover, it is difficult to determine and/or quantify a true return on investment associated with conventional asset management systems. In addition, current asset management systems are unable to project what a return on investment will or should be for a prospective asset management system purchase.

### SUMMARY

According to an aspect of the present disclosure, a method to calculate one or more key performance indicators (KPIs) relating to the performance of one or more assets (e.g., vehicles, containers, chassis, etc.) associated with a company. The method includes maintaining or identifying a set of asset performance information relating to one or more assets associated with a company (also referred to as “target assets”). Based on the asset performance information, one or more KPIs are calculated. According to embodiments of the disclosure, the calculated KPIs may include one or more of: a days in service rate, an activity rate, a fleet utilization rate, an operator utilization rate, an overtime rate, a sleeper rate, a peak fleet usage rate, a safety rate, or an OSHA compliance rate.

The KPIs may be used to determine one or more cost benefit measurements, which translate the KPI value into a monetized value or measurement. A report may be generated for provisioning to the one or more companies, wherein the report includes one or more of the asset performance information, the one or more KPIs, and/or the one more cost benefit measurements.

In an embodiment, the KPIs and/or cost benefit measurements may be used to perform intra-company comparisons (e.g., comparing multiple locations or sites including assets of a company) and inter-company comparisons (e.g., comparing multiple companies or peers in an industry) based on one or more common KPIs or cost benefit measurement serving as benchmarking metrics.

In additional embodiments, computing devices for performing the operations of the above described embodiments are also implemented. Additionally, in embodiments of the invention, a computer readable storage media stores methods for performing the operations of the above described embodiments.

### BRIEF DESCRIPTION OF THE DRAWINGS

The present invention will be understood more fully from the detailed description given below and from the accompanying drawings of various embodiments of the invention.

FIG. 1 illustrates an exemplary system architecture, in accordance with an embodiment of the present disclosure;

FIG. 2 illustrates an exemplary method for monitoring and measuring a performance of an asset, in accordance with an embodiment of the present disclosure;

FIG. 3 illustrates an exemplary report generated by an asset management system in accordance with an embodiment of the present disclosure;

FIG. 4 illustrates an exemplary method for performing an inter-company comparison based on key performance indicators, in accordance with an embodiment of the present disclosure; and

FIG. 5 is a block diagram of an exemplary computer system that may perform one or more of the operations described herein.

### DETAILED DESCRIPTION

A system and method for managing a collection of assets owned or operated by a company based on a monitoring of key performance indicators (KPIs) are described. Embodiments of the disclosure include the collection of performance information relating to one or more assets (e.g., vehicles) associated with the company. Based on the collected asset performance information, one or more KPIs are calculated. In an embodiment, the one or more KPIs are configured to enable a determination of a cost benefit measurement (e.g., a return on investment metric) for provisioning to the company. According to embodiments of the present disclosure, the calculated KPIs may include one or more of: a days in service rate, an activity rate, a fleet utilization rate, an operator utilization rate, an overtime rate, a sleeper rate, a peak fleet usage rate, a safety rate, or an OSHA compliance rate (each of which are described in greater detail below).

In one embodiment, the calculated KPIs may be used to determine a cost benefit measurement to enable a customer to quantify the current performance (e.g., utilization, return on invest (ROI) and/or potential of an asset, a collection of assets (e.g., a fleet of vehicles), and/or operators of the assets. For example, a company having multiple sites or locations (e.g., factories) including multiple fleets of vehicles, may employ the calculated KPIs and determined cost benefit measurements to perform an intra-company comparison of the fleets operating at the multiples locations.

Furthermore, in an embodiment, the present disclosure enables a company to use the KPIs for the purposes of performing an industry or inter-company comparison, such that the company can benchmark the performance of the company's assets against one or more other companies. Accordingly, a company may quantify and compare their asset performance to their peers or competitors using the KPIs as a uniform metric (e.g., a percentile ranking).

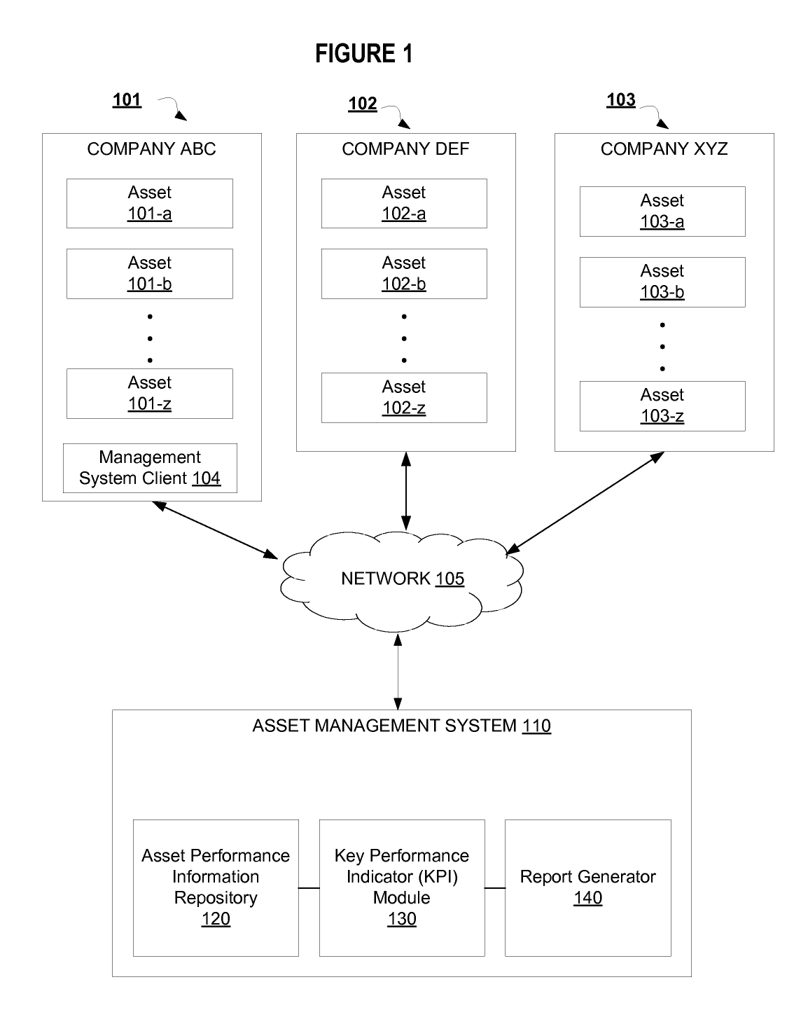

FIG. 1 illustrates an exemplary system architecture 100, in accordance with one embodiment of the present disclosure. System 100 includes an asset management system 110 including an asset performance information repository 120, a key performance indicator (KPI) module 130, and a report generator 140. The asset management system 110 communicatively couples to one or more companies (e.g., Company ABC 101, Company DEF 102, and Company XYZ 103) via a network 105. The network 105 may include any suitable communications network, such as, for example, the Internet, a wired or wireless network, such as an intranet, a local area network (LAN), a wide area network (WAN), a broadcast network, or the like. The asset management system 110 may be any type of computing device, for example, a device including a processing device (e.g., a processor), a computer-readable medium, and a memory. For example, the asset management system 110 may comprise one or more servers, desktop computers, portable digital assistants, mobile phones, laptop computers, portable media players, tablet computers, netbooks, notebooks, and/or personal computers.

Each company (e.g., Company ABC 101, Company DEF 102, Company XYZ 103) is associated with one or more assets that are owned and/or operated by the company and managed by the Asset Management System 110. As shown, Company ABC is associated with Asset 101-a, Asset 101-b, . . . and Asset 101-z; Company DEF is associated with Asset 102-a, Asset 102-b, . . . and Asset 102-z; and Company XYZ is associated with Asset 103-a, Asset 103-b, . . . and Asset 103-z.

In an embodiment, the collection of assets associated with a company (e.g., Asset 101-a, Asset 101-b, . . . and Asset 101-z associated with Company ABC) may be located at any number of different sites or locations. In an embodiment, the assets may include a locally housed device or communicator (e.g., an RFID device) configured to communicate with a local management system client 104 (e.g., as shown in FIG. 1 with respect to Company ABC), which in turn communicates with the Asset Management System 110. The management system client 104 may be any type of computing device, for example, a device including a processing device (e.g., a processor), a computer-readable medium, and a memory. In another embodiment, the assets may communicate directly with the Asset Management System 110. Any suitable arrangement and communication platform may be employed in order for information relating to the performance of the assets may be collected from the assets by the asset management system 110 and stored within the asset performance information repository 120.

The performance information repository 120 is configured to store the asset performance information and company information associated with the one or more companies 101, 102, and 103 (e.g., Company ABC, Company DEF, and Company XYZ) and their associated assets. The performance information repository 120 may be any suitable memory or data storage location, including a non-transitory computer readable storage medium, such as, but not limited to, any type of database, disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions. According to embodiments of the present invention, the performance information repository 120 may reside in any suitable location accessible by the KPI module 130, including, for example, in a network or cloud environment.

The asset performance information may include any information associated with the operation, performance, movement, productivity, location, identification, status, etc. of the asset. According to embodiments of the present disclosure, the asset performance information may include one or more of a number of days the asset is in service (e.g., within a selected period of time); a number of activity hours of the asset (e.g., within a selected period of time); a number of motion hours of an asset; a number of lift hours of an asset (e.g., an amount of time a lift of a forklift (i.e., the asset) is in operation); a number of login hours (e.g., hours an asset is logged into); a measure of an amount of time an operator is on break (e.g., not logged into an asset); a number of “sleeper” hours; a number of “seat” hours (e.g., a number hours a seat switch or floor switch associated with a vehicle is depressed or engaged); a number of maximum asset simultaneously logged into during a selected interval within a period of time (e.g., an identification of the assets logged into at any given time interval); a number of impacts or accidents associated with an asset; a number of periodic (e.g., hourly, daily, weekly, monthly, etc.) checklists that are completed with respect to an asset; a number of non-compliance lockout events associated with an asset (e.g., an event indicating that a checklist was started, but not completed).

According to embodiments of the present disclosure, the company information may include any information associated with a particular company, such as, for example, a number of assets owned, operated, and/or otherwise under the control of a company (e.g., on a site-by-site or company-wide basis); a number of working days within a selected time period (e.g., on a site-by-site or company-wide basis); a number of working hours in a selected time period (e.g., a number of daily working or shift hours, or daily working hours of a plant, site, or location); or a number of operators associated with an asset or collection of assets. The company information may be provided to the asset management system 110 by the company in any suitable manner, including, but not limited to, by transmitting or exporting one or more files including the information to the asset management system 110, by entering the information via a graphical user interface communicatively coupled to the asset management system 110, by responding to a request for the information generated by the asset management system 110, or the like.

In an embodiment, default parameters or settings may be used for the company information in cases when a company has not provided specific values or/or preferences. The default parameters and settings may be manually changed or modified by the company. For example, the daily working hours for a company may be set to a default value of 7 hours a day. In an embodiment, the default parameters may be determined as a function of the company information, such as, for example, by normalizing values (e.g., the average number of hours per work day) across multiple companies (e.g., an industry perspective) or across multiple sites or locations within the company.

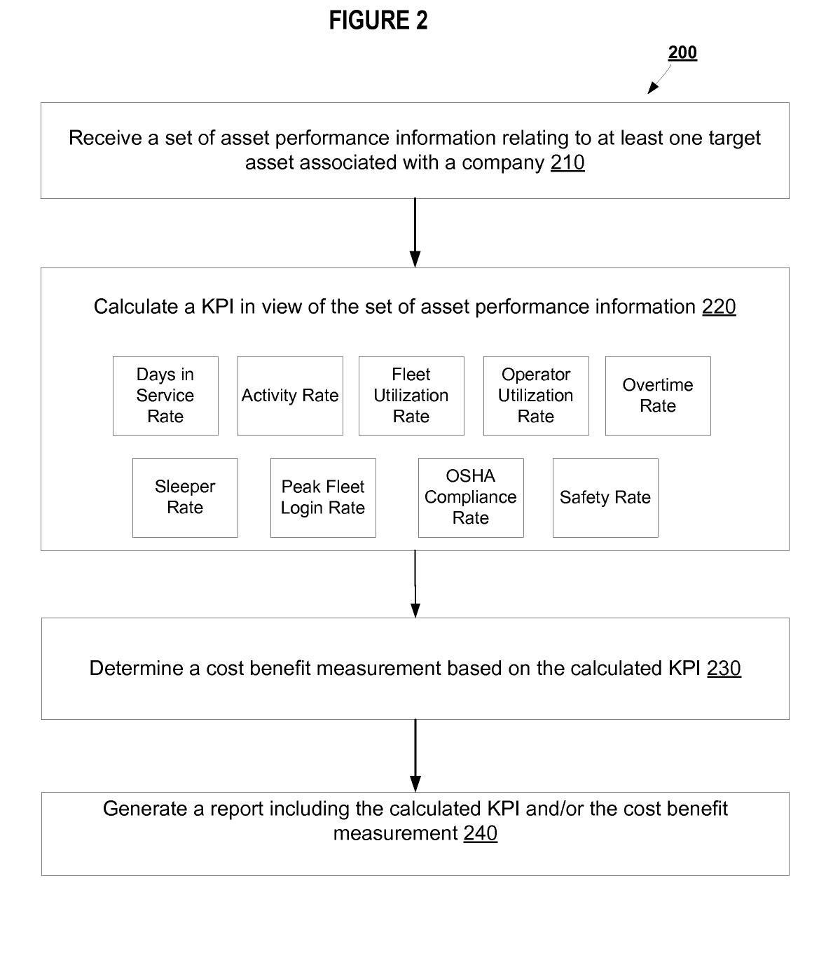

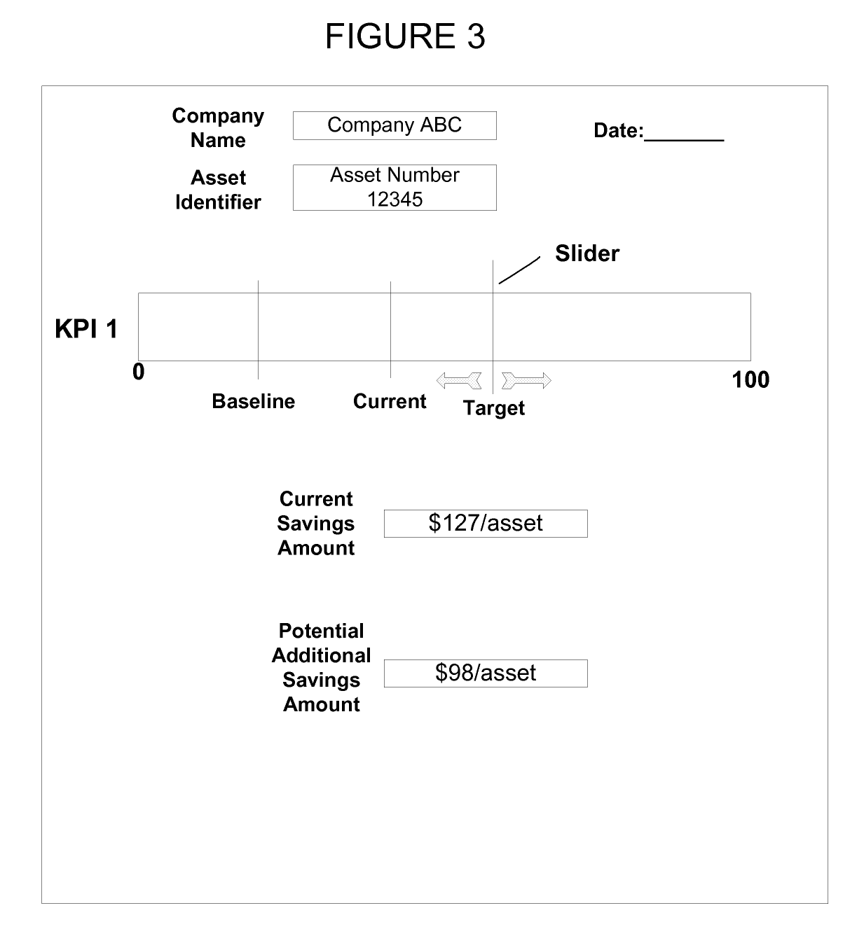

As shown in FIG. 1, the asset management system 110 includes or is communicatively coupled to the KPI module 130. The KPI module 130 may be implemented in hardware, software, firmware, or any combination thereof, and may include a set of instructions executable by a processing device to perform the operations described in greater detail with respect to FIGS. 2 and 3. In embodiments of the invention, the KPI module 130 processes the asset performance information received from the asset performance information repository 120 to calculate one or more KPIs and cost benefit measurements associated with the one or more assets. According to embodiments of the present disclosure, the KPIs calculated by the KPI module 130 represent a measurement of a performance metric associated with the one or more assets, including, but not limited to, a days in service rate, an activity rate, a fleet utilization rate, an operator utilization rate, an overtime rate, a sleeper rate, a peak fleet usage rate, a safety rate, and an OSHA compliance rate. In an embodiment, the calculated KPI may be a percentile ranking (e.g., on a scale from 0 to 100) which provides a basis for comparing the performance of an asset or group of assets on a site-to-site (or location-to-location) basis within a company or a company-to-company basis (e.g., comparing a common KPI of a first company to that of one or more other companies). The aforementioned KPIs are described in greater detail below in connection with FIG. 2. In an embodiment, the one or more KPIs may be used to establish a “baseline” associated with a level of performance at a time of installation or initial operation of an asset. In an embodiment, the baseline values for the one or more KPIs may be used as point of comparison to measure a change in performance over time. For example, at the time of installation, a baseline set of KPI values may be calculated. Following a period of time (e.g., a month, a quarter, a year, etc.), the KPI values may be calculated and compared to the baseline KPI values. The comparison may enable a company to determine a difference in the one or more KPIs which may be quantified by a cost benefit measurement.

The cost benefit measurement represents a monetized value or unit of measurement based on the one or more calculated KPIs. In an embodiment, the cost benefit measurement enables a company to consider the performance information in a financial context, to formulate, for example, a return on investment (ROI) assessment or investment potential assessment. In an embodiment, the cost benefit measurement may be a quantified monetary metric (e.g., in terms of dollars) of the level of savings achieved by a company as a result of the improvement of the one or more KPI values over time based on a comparison of the baseline KPI value(s). In an embodiment, the cost benefit measurement may be a quantified monetary metric based on a comparison of multiple sites or locations of a company In an example, the asset management system may determine that an X dollar savings may be achieved by a company by operating a first site at a level consistent with a second site, based on a comparison of the KPIs over time for the two sites.

In an embodiment, the cost benefit measurement may be include a quantified metric of a projected or anticipated cost savings for a potential fleet or set of assets. Advantageously, a company may project, forecast, estimate and/or predict a potential cost savings for a new fleet of assets by comparing the company's existing productivity measurements with industry standard KPIs determined by the asset management system (e.g., one or more average KPI values in an industry).

According to embodiments of the present disclosure, the KPI module 130 is further communicatively coupled to the report generator 140. The report generator 140 may be implemented in hardware, software, firmware, or any combination thereof, and may include a set of instructions executable by a processing device to perform the operations described in greater detail with respect to FIGS. 2 and 3. In an embodiment, the report generator 140 generates one or more reports including the calculated KPI and cost benefit measurement information for provisioning to one or more companies. In addition, the one or more reports may include information relating to an intra-company comparison (e.g., a location-to-location comparison of KPIs and/or cost benefit measurements for a particular company) and/or an inter-company comparison (e.g., a benchmarking comparison of KPI and/or cost benefit measurement comparison of multiple companies, such as peers in an industry). The report generator 140 may provision the report to the one or more companies 101, 102, 103 in any suitable format and/or fashion, including, but not limited to, by electronic communication (e.g., e-mail, web-based posting, file transfer), via a graphical user interface accessible by a user associated with the company, via a print out or other physical reproduction providing to the company, etc.

Embodiments of the present disclosure may operate within a single server device or on multiple server devices. Although in the asset management system 110, the asset performance information repository 120, the KPI module 130, and the report generator 140 are depicted in FIG. 1 as disparate components, these components may be implemented together in a single device or networked in various combinations of multiple different devices that operate together. Examples of devices may include, but are not limited to, servers, mainframe computers, networked computers, process-based devices, and similar type of systems and devices. Furthermore, although as part of Company ABC's system 101, the management system client 104 may be employed in connection with any number of the companies' systems. Moreover, although not shown in FIG. 1, the companies' systems 101, 102, 103 may represent assets located at any number of different locations or sites.

FIG. 2 illustrates a flow diagram of an embodiment of a method for generating a report including asset performance information, KPI(s), cost benefit measurement(s), or a combination thereof. The method may be performed by processing logic that may include hardware (circuitry, dedicated logic, etc.), software (such as is run on a general purpose computer system or a dedicated machine), or a combination of both. In one embodiment, the method illustrated in FIG. 2 may be performed by the KPI module 130 and the report generator 140 running on a server machine or another machine as described with respect to FIG. 1.

At block 210 of method 200, an asset management system (e.g., the asset management system 110 of FIG. 1) receives a set of asset performance information relating to at least one target asset associated with a company. In an embodiment, the set of asset performance information may include any number of elements of information relating to the performance of the at least one target asset, and may be received by the asset management system in any suitable fashion for storage in a memory (e.g., the asset performance information repository 120 of FIG. 1). It is noted that the at least one target asset may include a single asset of the company, multiple assets located or operated at a single site of the company (e.g., a first location) or, multiple assets located or operated at multiple locations of the company (e.g., a first location and a second location).

In block 220, the asset management system calculates one or more KPIs in view of the set of asset performance information associated with the at least target asset. In one embodiment, the KPI module 120 of FIG. 1 receives the set of asset performance information from the asset performance information repository 120, from the at least one target asset, or from a computer associated with the company (e.g., the management system client 104 of FIG. 1). Upon receipt of the set of asset performance information, the KPI module performs operations to determine one or more KPIs. In block 230, the asset management system determines one or more cost benefit measurements based on the one or more calculated KPIs. Provided below is a description of exemplary KPIs and cost benefit measurements that may be calculated by the asset management system in blocks 220 and 230. It is noted that any combination of the KPIs and cost benefit measurements described below in connection with blocks 220 and 230 may be determined for inclusion on a report generated in block 240.

In an exemplary embodiment, the KPI module calculates a KPI representing a days in service rate, in block 220. The days in service rate represents a number of days an asset is used by one or more operators within a time period (i.e., “in service” hours) divided by a total number of working days in the time period (e.g., the number of days the location of the target asset (e.g., the site or facility) is open during the selected time period). In an example, if the target asset at location (L) is used for available for use (in service) for 4.2 days in the month of May (e.g., the selected time period) and location L is open for 24 days in May, then the days in service rate may be 0.175. In an embodiment, the days in service rate of 0.175 may be translated to a percentile ranking (e.g., on a scale of 0 to 100) for benchmarking purposes (e.g., intra-company comparisons or inter-company comparisons). In an embodiment, a cost benefit measurement may be determined including an ROI calculation based on a measure of an improvement in one or more KPIs (e.g., based on a measure of the change of the KPIs over time based on a comparison with one or more baseline KPI values).

Advantageously, the days in service rate provides the company with a measurement and/or metric relating to the maintenance of the asset, and represents a total number of days that the asset was available according to maintenance guidelines. In an embodiment, the asset may be deemed unavailable (or “out of service”) due to an accident, non-compliance with service/operation/safety guidelines, OSHA lockouts, repair/maintenance downtime, etc. The days in service rate may be indicative of maintenance effectiveness, fleet or collection of asset capacity tracking, asset overuse and under-utilization detection, and operator bias toward one or more assets. In an embodiment, a related or complimentary KPI relating to the days in service rate may be determined, such as an impact lockout rate or a non-compliance lockout rate. In an embodiment, an impact lockout rate may include a measurement and/or metric relating to the length of time that an asset is unavailable due to an impact. The impact lockout rate may be used to quantify the time taken by a supervisor and/or manager to evaluate the asset and/or the time taken by maintenance personnel to repair the asset. In an embodiment, a non-compliance lockout rate relates may include a measurement and/or metric relating to a length of time that an asset is unavailable due to a non-completion of a checklist within a preset or prescribed time. The non-compliance lockout rate may bue used to measure the effect of checklist non-compliance on a company, and may be an indicator of operator training issues and/or a failure of supervisor to act within a prescribed time.

In addition, in an embodiment, a derivative KPI representing an hours in service rate may be calculated based on the days in service rate.

In block 230, the KPI module determines a cost benefit measurement based on the calculated days in service rate KPI. In an embodiment, the KPI module determines the cost benefit measurement by multiplying a daily cost of an asset (e.g., an hourly cost of the asset multiplied by a number of hours the asset is operated) multiplied by the days in service rate. Continuing the example above, if the target asset costs the company $2.19 per hour and the target asset is operated for a total of 6.2 hours per day, then the cost benefit measurement is approximately 2.38. This cost benefit measurement may be used to provide the company with a monetized measure of the effectiveness of the asset, an indication whether or not there is a need to decrease or increase spare assets, an identification of assets that are being used less frequently than others, and/or a 1% gain can represent almost 4 days on increased vehicle availability. For example, if a company maintains a year-round 24 hour operation, an increase in asset activity by 1% represents 88 hours (i.e., approximately 4 working days) of additional activity of the asset.

In an exemplary embodiment, the KPI module calculates a KPI representing an activity rate, in block 220. The activity rate represents an average number of hours per a selected time period that an asset was in use within a selected time period. In an embodiment, the activity rate represents a number of activity hours of an asset within a selected time period divided by a number of working hours in the selected time period.

In an embodiment, the activity hours may be represented by a number of motion hours (e.g., the time the asset is in motion), plus the number of lift hours (e.g., the number of hours the lift portion of the asset, such as a forklift, is in operation) minus any overlap hours (e.g., the time the asset is both in motion and the lift is in operation). In an embodiment, the number of working hours represents the total number of working hours (e.g., hours the asset could be used/working in the selected time period). The activity rate may be indicative of operator productivity, overtime needs, increased or decreased staffing or asset requirements, etc. In an embodiment, a related or complimentary KPI relating to the activity rate may be determined, such as an average motion hours per day per operator rate, an overtime rate, and/or an operator utilization rate.

In block 230, the KPI module determines a cost benefit measurement based on the calculated activity rate KPI. In an embodiment, the KPI module determines the cost benefit measurement by multiplying an hourly pay rate of an operator by the activity rate. According to embodiments of the present disclosure, the determined cost benefit measurement may enable a company to realize an increased ROI in cases, for example, when a gain is realized per additional operator activity time (e.g., a 1% ROI gain per every 15 minutes of operator activity per day, or a 1% gain per every 1% of labor cost savings, fleet cost savings, and/or asset cost savings).

In an exemplary embodiment, the KPI module calculates a KPI representing a fleet utilization rate, in block 220. The fleet utilization rate represents a measure of asset activity as a percentage of asset capacity for a selected location (e.g., a given plant or site). In an embodiment, the fleet utilization rate represents a total number of activity hours of one or more assets at a location on a given day divided by a product of a number of daily plant hours (e.g., a number of hours the location is open in a day) and a number of assets in service during the selected day. The fleet utilization rate may be indicative of a total capacity of the location/plant/site based on available assets, under-utilization issues, fleet expansion needs and/or asset overuse. In an embodiment, a related or complimentary KPI relating to the fleet utilization rate may be determined, such as an operator utilization rate, a simultaneous login rate, a simultaneous motion rate, and/or a peak fleet usage rate (e.g., a peak or maximum number of vehicles used based on motion, load, etc.).

In block 230, the KPI module determines a cost benefit measurement based on the calculated fleet utilization rate KPI. In an embodiment, the KPI module determines the cost benefit measurement based on the fleet utilization rate according to the following equation:

(1−fleet utilization rate)×(an hourly asset cost)×(a number of assets in service).

According to embodiments of the present disclosure, the determined cost benefit measurement may enable a company to compare asset utilization across multiple locations/sites/plants, right-size asset fleets, identify capacity shortfalls, and realize an increased ROI in cases, for example, when a gain is realized per opportunity cost reduction of unused assets. In an embodiment, the cost benefit measurement may be used to determine a level of progress and/or improvement since installation or initial operation of one or more assets by analyzing a difference between a current KPI and the baseline KPI (e.g., the KPI value at the time of installation/initial operation).

In an exemplary embodiment, the KPI module calculates a KPI representing an operator utilization rate, in block 220. The operator utilization rate represents a measure of operator activity as a percentage of location/site/plant operator capacity. In an embodiment, the fleet utilization rate represents a number of activity hours of one or more assets within a selected time period divided by a number of daily plant operator hours (e.g., a number of hours that the location/site/plant is open multiplied by a number of operators logged into an asset each day). The operator utilization rate may be indicative of a total capacity of the location/plant/site based on available operators, overtime needs, excess operator capacity, capacity shortfalls, and/or workforce expansion needs. In an embodiment, a related or complimentary KPI relating to the operator utilization rate may be determined, such as, for example, a fleet utilization rate, an overtime rate, a sleeper rate, etc.

In block 230, the KPI module determines a cost benefit measurement based on the calculated operator utilization rate KPI. In an embodiment, the KPI module determines the cost benefit measurement based on the operator utilization rate according to the following equation:

(1−operator utilization rate)×(an hourly operator cost)×(a number of operators).

According to embodiments of the present disclosure, the determined cost benefit measurement may enable a company to compare operator utilization across multiple locations/sites/plants, determine overtime requirements, and realize an increased ROI in cases, for example, when a gain is realized per opportunity cost reduction of inactive operators and/or unused operator time.

In an exemplary embodiment, the KPI module calculates a KPI representing an overtime rate, in block 220. The overtime rate represents a measure of overtime hours as a percentage of location/site/plant capacity (herein “plant operator capacity”). In an embodiment, the overtime rate represents a number of overtime hours divided by the plant operator capacity. In an embodiment, the overtime hours are calculated according to the following equation:

(login hours)+(break time)−(expected regular hours).

In an embodiment, the company may establish a number for the expected regular hours (e.g., the expected regular hours may be calculated based on a 7 hour work day or 35 hour week). In an embodiment, the plant operator capacity represents a number of hours that the plant is open multiplied by the number of operators for a selected time period (e.g., each day). The overtime rate may be indicative of an overtime cost as compared to excess operator capacity or a need for workforce expansion. In an embodiment, a related or complimentary KPI relating to the overtime rate may be determined, such as, for example, a fleet utilization rate, an operator utilization rate, a sleeper rate, etc.

In block 230, the KPI module determines a cost benefit measurement based on the calculated overtime rate KPI. In an embodiment, the KPI module determines the cost benefit measurement based on the overtime rate according to the following equation:

(overtime rate)×(an hourly operator cost)×(an overtime pay rate)×(a number of operators with overtime).

According to embodiments of the present disclosure, the determined cost benefit measurement may enable a company to determine a true overtime requirement measurement, compare overtimes across multiple locations/sites/plants, determine enterprise standard and measure overtime as a function of fleet capacity and/or operator capacity.

In an exemplary embodiment, the KPI module calculates a KPI representing a sleeper rate, in block 220. The sleeper rate represents a measure of “sleeper hours” as a percentage of login hours. In an embodiment, sleeper hours are defined as the time sitting or standing on an asset (e.g., a vehicle) with no measurable activity on the vehicle. In an embodiment, the sleeper rate may be calculated according to the following equation:

((seat hours)−(motion hours+lift hours−overlap hours))/login hours.

In an embodiment, the sleeper rate may be indicative of inactive hours, extra capacity, etc. In an embodiment, a related or complimentary KPI relating to the sleeper rate may be determined, such as, for example, a fleet utilization rate, an operator utilization rate, an overtime rate, etc. In an embodiment, the sleeper rate may be used to determine a derivative KPI, such as, for example, a sleeper rate as a function of overtime hours (e.g., the sleeper rate divided by a number of overtime hours).

In block 230, the KPI module determines a cost benefit measurement based on the calculated sleeper rate KPI. In an embodiment, the KPI module determines the cost benefit measurement based on the sleeper rate according to the following equation:

(sleeper rate)×(an operator hourly rate).

According to embodiments of the present disclosure, the determined cost benefit measurement may enable a company to measure the sleeper rate against fleet capacity and/or operator capacity, identify overtime reductions, monitor idle activity, and make operator behavioral modifications.

In an exemplary embodiment, the KPI module calculates a KPI representing a peak fleet usage rate, in block 220. The peak fleet usage rate represents a measure of fleet utilization based upon a peak fleet use in a selected period of time compared to a number of assets available during the selected time period. In an embodiment, the peak fleet use may represent a maximum number of vehicles in use for a defined interval (e.g., any 5 minute interval), in a time period. In an embodiment, the peak fleet usage rate represents a maximum number of vehicles logged into simultaneously during any predetermined time interval (e.g., a 5 minute interval, a 10 minute interval, etc.) over the selected period of time (e.g., an hour, a day, a week, a month, a year, etc.). In an embodiment, the peak fleet usage rate may be calculated according to the following equation:

(maximum vehicle simultaneous login)/(total number of vehicles in service during a selected time period).

In an embodiment, the peak fleet usage rate may be indicative of a fleet capacity deficit, a fleet spare capacity, a need for a modification to a fleet size (e.g., fleet rightsizing). In an embodiment, a related or complimentary KPI relating to the peak fleet usage rate may be determined, such as, for example, a fleet utilization rate, a peak fleet motion rate, etc.

In block 230, the KPI module determines a cost benefit measurement based on the calculated peak fleet usage rate KPI. In an embodiment, the KPI module determines the cost benefit measurement based on the peak fleet usage rate according to the following equation:

(unused hours rate)×(hours)×(vehicle hourly cost);

wherein the “unused hours rate” represents a number of excess hours divided by a number of available hours.

According to embodiments of the present disclosure, the determined cost benefit measurement may enable a company to determine an opportunity cost of unused capacity, a measure of fleet utilization, and/or quantify spare capacity.

In an exemplary embodiment, the KPI module calculates a KPI representing a safety rate, in block 220. The safety rate represents a measure of impacts or accidents associated with one or more assets per an activity hour (e.g., the activity hours may be represented by a number of motion hours (e.g., the time the asset is in motion), plus the number of lift hours (e.g., the number of hours the lift portion of the asset, such as a forklift, is in operation) minus any overlap hours (e.g., the time the asset is both in motion and the lift is in operation)). In an embodiment, a correlation is derived by comparing the impact level or number of impacts (or accidents) per activity hour to enable a company to compare impact levels across different time periods, asset groups and/or locations. In an embodiment, the safety rate may be calculated by dividing a number of impacts by a total number of activity hours.

In an embodiment, the safety rate may be indicative of excessive impacts (e.g., based on a comparison of impacts during certain time periods, asset groups and/or locations). In an embodiment, a related or complimentary KPI relating to the safety rate may be determined, such as, for example, a measure of a high amount of impacts per activity hour or a measure of the severity of the impacts as a function of the activity hour.

In block 230, the KPI module determines a cost benefit measurement based on the calculated safety rate KPI. In an embodiment, the KPI module determines the cost benefit measurement based on the safety rate by multiplying the safety rate KPI by an average property damage cost per impact (e.g., an average report cost of approximately $1,200 per impact, as estimated by OSHA). In an embodiment, the safety rate KPI may be an average company-specific property damage cost (e.g., the property damage cost realized by that particular company).

According to embodiments of the present disclosure, the determined cost benefit measurement may enable a company to reduce personnel injuries, asset damage, facility/site damage, and/or product damage.

In an exemplary embodiment, the KPI module calculates a KPI representing an OSHA compliance rate, in block 220. The OSHA compliance rate represents a measure of a company's compliance with OSHA reporting standards (e.g., a measure of the number of OSHA reports that are compliant). In an embodiment, the OSHA compliance rate may be calculated according to the following equation:

(number of checklists completed in a selected time period)/(a number of checklists completed in a selected time period+a number of non-compliance lockout events)

In an embodiment, the non-compliance lockout event indicates that an OSHA checklist was started, but not completed. In an example, the OSHA compliance rate for a particular date may be calculated by dividing the total number of checklists completed on the particular date by the sum of the total number of checklists completed on the particular date and the number of non-compliance lockout events. In an embodiment, the OSHA compliance rate may be indicative of an effectiveness of OSHA checklist compliance. In an embodiment, a related or complimentary KPI relating to the OSHA compliance rate may be determined, such as, for example, the safety rate.

In an embodiment, a cost benefit measurement may be determined based on the OSHA compliance rate. For example, the OSHA compliance rate may be used to determine a likelihood that the company will fall below a threshold associated with an audit which triggers a monetary penalty. In this example, the higher the OSHA compliance rate, the lower the likelihood that the company's activity will result in a fine or penalty in the event of an audit.

According to embodiments of the present disclosure, based on a consideration of the OSHA compliance rate KPI, a company may increase the rate to improve safe asset operation and improve compliance with OSHA requirements.

With reference to FIG. 2, in block 240, a report is generated including one o or more of the set of asset performance information, the one or more calculated KPIs, or the one or more cost benefit measurements. It is noted that any combination of the above-described KPIs and cost benefit measurements may be included in the generated report. In an embodiment, the one or more KPIs and/or cost benefit measurements are provided by the KPI module 130 of FIG. 1 to the report generator 140 for generating of the report. In an embodiment, the report generator 140 may provision the generated report to one or more companies via any suitable communications method (e.g., via a GUI, via a web posting, via an electronic communication, etc.). The generated report may be in any suitable format (e.g., layout, style, file type, etc.) for presentation of the calculated KPI(s) and/or cost benefit measurement(s).

FIG. 3 illustrates an exemplary report generated in accordance with one or more embodiments of the present disclosure. As shown, a report may include one or more KPIs (e.g., KPI 1 in FIG. 3) for one or more assets (e.g., Asset Number 12345 in FIG. 3) of a company (e.g., Company ABC as shown in FIG. 3) depicted on a scale (e.g., a scale of 0 to 100, as shown in FIG. 3). The scale may include an indication of a baseline value of the KPI (e.g., the value of the KPI at the time of installation and/or initial operation of the asset) for Asset Number 12345, a current value of KPI 1 (e.g., as of the date of the report), and a target value of KPI 1 established by the company. In an embodiment, the baseline value may be set as the industry median, determined by the asset management system based on performance information collected with respect to other companies in Company ABC's industry.

In an embodiment, the report may further include any number of cost benefit measurements, such as, for example, a current savings amount and a potential additional savings amount. The current savings amount may be determined according to the following equation:

(Current−Baseline)×(% Savings associated with KPI 1)

In the example shown in FIG. 3, the current savings amount realized as a result of the improvement or increase in the KPI 1 value (as denoted by the current value vs. the baseline or original value) is $127. Accordingly, Company ABC may use the report to ascertain a monetized and/or quantified cost savings or ROI metric associated with the improvement of KPI 1.

In an embodiment, the report may further include a potential additional savings amount. The potential additional savings amount may be determined according to the following equation:

(Target−Current)×(% Savings associated with KPI 1)

In the example shown in FIG. 3, the potential additional savings amount that may be realized by Company ABC if the value of KPI 1 is increased from its current value to the target value is $98. As indicated by the arrows in FIG. 3, the target may be adjusted by a user. In an embodiment, a graphical user interface may be presented to a user which enables the user to adjust the target value using a slider or other suitable mechanism. In an embodiment, the report may illustrate a change in the potential additional savings amount as the target value is changed, to enable a user to visualize the increase or decrease in the potential additional savings amount as a function of the setting of the target value. It is noted that the target value set by a company may be stored and maintained by the asset management system for use in the generation of further reports.

In an embodiment, a company (e.g., Company ABC in FIG. 1) may interact with the asset management system in order to request a report. In this embodiment, the company may specify one or more KPIs and/or cost benefit measurements that the company would like included in the report. Accordingly, based on the request, the asset management system would identify the appropriate set of asset performance information associated with the company (in block 210), calculated the one or more requested KPIs (in block 220), determine the one or more cost benefit measurements based on the calculated KPI(s) (in block 230), and generate a report including the one or more KPIs and/or the cost benefit measurement(s).

In an embodiment, the report may include an intra-company comparison of information associated with a company. The intra-company comparison may include a benchmarking comparison of one or more KPIs and/or cost benefit measurements for the company based on a comparison metric (e.g., a location-based comparison, an asset group comparison, an operator-based comparison, etc.). A company may interact with the asset management system to customize a report to include any variation and/or combination of benchmarking comparisons based on the company's asset performance information. For example, a company having multiple locations (e.g., location 1 and location 2) may request the generation of an intra-company comparison report to compare the activity rate KPI and associated cost benefit measurement for a first group of assets operating at location 1 to the activity rate KPI and associated cost benefit measurement for a second group of assets operating at location 2.

In an embodiment, the report generated by the asset management system may include any of the one or more KPIs and/or cost benefit measurements, in any combination thereof, and may be presented as a function of any number of comparison points or factors. For example, the report may present the KPI and/or cost benefit measurement information by industry, by asset type, by asset manufacturer, by operation type (e.g., shipping, receiving, etc.), by geography (e.g., country, state, region, etc.), by a gross domestic product measurement, or the like.

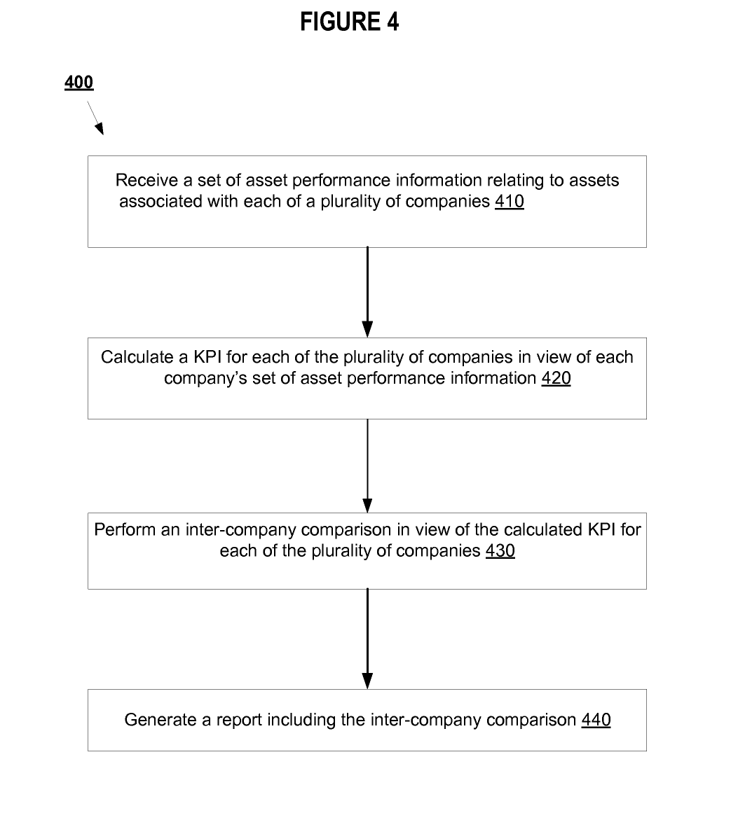

FIG. 4 illustrates a flow diagram of an embodiment of a method for generating a report including an inter-company comparison. The method may be performed by processing logic that may include hardware (circuitry, dedicated logic, etc.), software (such as is run on a general purpose computer system or a dedicated machine), or a combination of both. In one embodiment, the method illustrated in FIG. 4 may be performed by the KPI module 130 and the report generator 140 running on a server machine or another machine as described with respect to FIG. 1.

At block 410 of method 400, an asset management system (e.g., the asset management system 110 of FIG. 1) receives a set of asset performance information relating to one or more assets associated with multiple companies (e.g., Company ABC, Company DEF and Company XYZ of FIG. 1). In an embodiment, the various sets of asset performance information are collected and stored in a repository (e.g., the asset performance information repository 120 of FIG. 1) with an association to the appropriate company.

At block 420, the asset management system calculates one or more KPIs for each of the multiple companies in view of the respective company's set of asset performance information. The one or more KPIs may be calculated in accordance with the methodology described above in connection with FIG. 2. In block 430, the asset management system performs an inter-company comparison in view of the calculated KPI(s) for each of the multiple companies. For example, in block 420, an operator utilization rate KPI may be calculated for Company ABC, Company DEF and Company XYZ.

Next, in block 430, the asset management system may compare the three calculated operator utilization rate KPIs to enable the benchmarking of the three companies with respect to this performance metric. In an embodiment, the operator utilization rate KPI may be embodied as a percentile ranking on a scale of 0 to 100. Continuing the above example, Company ABC may have an operator utilization rate of 47, Company DEF may have an operator utilization rate of 29, and Company XYZ may have an operator utilization rate of 62. In block 430, these values may be compared (i.e., an inter-company comparison) and a report may be generated including the inter-company comparison, in block 440. The inter-company comparison may be in any suitable form and/or format, such as, for example, in a tabular format, graphical format, chart format, etc. In an embodiment, the chart may make the one or more other companies anonymous, so that the report does not identify them by name.

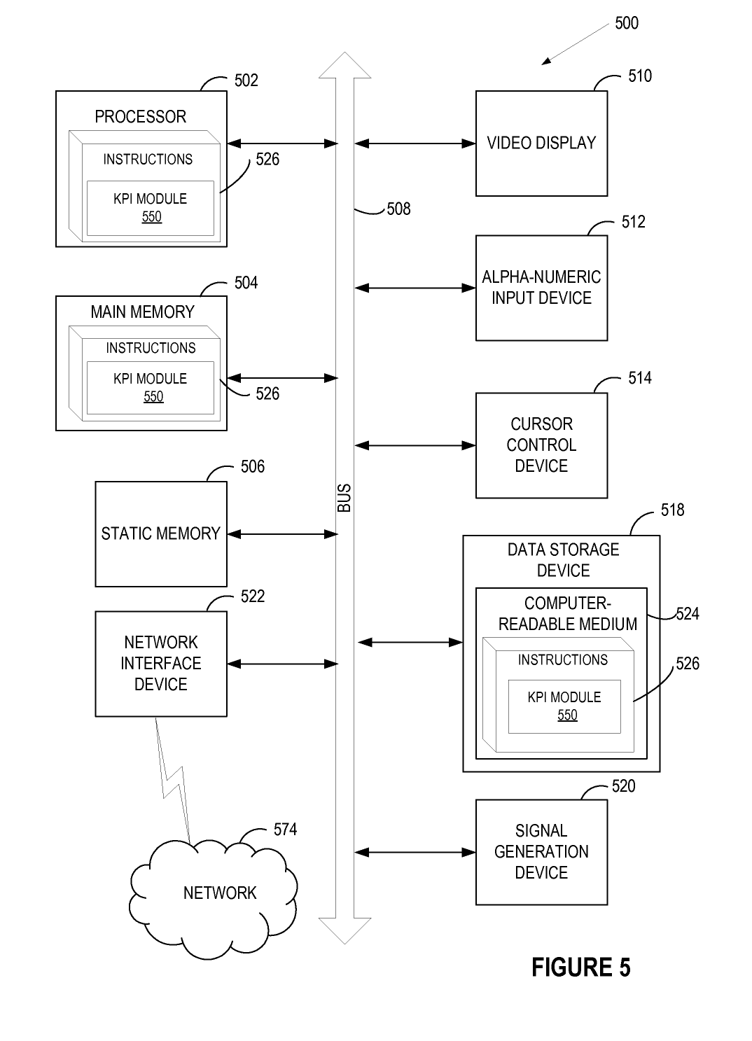

FIG. 5 illustrates a exemplary machine in the form of a computer system 500 within which a set of instructions, for causing the machine to perform any one or more of the methodologies and operations discussed herein, may be executed. In alternative embodiments, the machine may be connected (e.g., networked) to other machines in a LAN, an intranet, an extranet, or the Internet. The machine may operate as a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 508.

Processing device (e.g., a processor) 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting computer-readable storage media. The instructions 526 may further be transmitted or received over a network 574 via the network interface device 522.

In one embodiment, the instructions 526 include instructions for a key performance indicator (KPI) module 550, which may correspond to KPI module 120 of FIG. 1, and/or a software library containing methods that call an object detection/recognition engine. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “calculating”, “determining”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this disclosure to “one implementation,” or “an implementation,” or “one embodiment,” or “an embodiment” means that a particular feature, structure, or characteristic described in connection with the implementation or embodiment is included in at least one implementation or one embodiment. Thus, the appearances of the phrase “in one implementation,” or “in an implementation,” or “in one embodiment,” or “in an embodiment” in various places throughout this specification can, but are not necessarily, referring to the same implementation or embodiment, depending on the circumstances. Furthermore, the particular features, structures, or characteristics may be combined in any suitable manner in one or more implementations or embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

We claim:

1. A method comprising:
receiving, by a processing device, a set of asset performance information relating to at least one target asset associated with a company;
calculating, by the processing device, a key performance indicator (KPI) in view of the set of asset performance information;
determining, by the processing device, a cost benefit measurement based on the calculated KPI; and
generating, by the processing device, a report comprising the cost benefit measurement.

2. The method of claim 1, wherein the set of asset performance information comprises a number of days the at least one target asset is in service within a selected time period, and wherein the KPI comprises a days in service rate representing the number of days the target asset is in service divided by a total number of working days in the selected time period.

3. The method of claim 1, wherein the set of asset performance information comprises a number of activity hours of the at least one target asset within a selected time period, and wherein the KPI comprises an activity rate representing the number of activity hours divided by a total number of working hours in the selected time period.

4. The method of claim 1, wherein the set of asset performance information comprises a number of activity hours of the at least one target asset at a location within a selected time period, and a total number of assets in service at the location, and
wherein the KPI comprises a fleet utilization rate representing the number of days the number of activity hours divided by a product of the total number of assets in service at the location and a number of daily plant hours associated with the location.

5. The method of claim 1, wherein the set of asset performance information comprises a number of activity hours of the at least one target asset within a selected time period and a number of operators associated with the at least one target asset, and
wherein the KPI comprises an operator utilization rate representing the number of days the number of activity hours divided by a product of the total number of operators and a number of daily shift hours.

6. The method of claim 1, wherein the set of asset performance information comprises a number of overtime hours associated with a location and a total number of operators associated with the location, and
wherein the KPI comprises an overtime rate representing the number of overtime hours divided by a product of the total number of operators and a number of daily shift hours.

7. The method of claim 1, wherein the set of asset performance information comprises a number of sleeper hours associated with the at least one target asset within a selected time period and a number of login hours within the selected time period, and
wherein the KPI comprises a sleeper rate representing the number of sleeper hours divided by the number of login hours.

8. The method of claim 1, wherein the set of asset performance information comprises a number of simultaneous logins in an interval within a selected time period and a total number of active assets within the selected time period, and
wherein the KPI comprises a peak fleet usage rate representing the number of simultaneous logins divided by the total number of active assets.

9. The method of claim 1, wherein the set of asset performance information comprises a number of impacts within a selected time period and a total number of activity hours within the selected time period, and
wherein the KPI comprises a safety rate representing the number of impacts divided by the total number of activity hours.

10. The method of claim 1, wherein the set of asset performance information comprises a number of completed checklists within a selected time period and a number of non-compliance lockout events within the selected time period, and
wherein the KPI comprises an Occupational Safety and Health Administration (OSHA) compliance rate representing the number of completed checklists divided by a sum of the number of completed checklists and the number of non-compliance lockout events.

11. The method of claim 1, wherein the set of asset performance information comprises asset performance information associated with a first location associated with the company and a second location associated with the company.

12. The method of claim 11, further comprising generating an intra-company comparison comparing the KPI associated with the first location to the KPI associated with the second location.

13. The method of claim 1, wherein the cost benefit measurement comprises a return on investment percentile ranking.

14. A method comprising:
receiving, by a processing device, a set of asset performance information relating to a plurality of assets associated with each of a plurality of companies;
calculating, by the processing device, a KPI for each of the plurality of companies based on the associated set of asset performance information;
performing, by the processing device, an inter-company comparison in view of the calculated KPI for each of the plurality of companies; and
generating a report comprising the inter-company comparison.

15. The method of claim 14, wherein the KPI comprises at least one of a days in service rate, an activity rate, a fleet utilization rate, an operator utilization rate, an overtime rate, a sleeper rate, a peak fleet usage rate, a safety rate, or an OSHA compliance rate.

16. The method of claim 14, wherein the inter-company comparison comprises a quantified benchmark comparing the KPI of a first company of the plurality of companies and the KPI of a second company of the plurality of companies.

17. A non-transitory computer-readable medium storage medium comprising instructions that, when executed by a processing device, cause the processing device to perform operations comprising:
receiving a set of asset performance information relating to at least one target asset associated with a company;
calculating a KPI in view of the set of asset performance information;
determining a cost benefit measurement based on the calculated KPI; and
generating a report comprising the cost benefit measurement.

18. The non-transitory computer-readable medium of claim 17, wherein the KPI comprises at least one of a days in service rate, an activity rate, a fleet utilization rate, an operator utilization rate, an overtime rate, a sleeper rate, a peak fleet usage rate, a safety rate, or an OSHA compliance rate.

19. The non-transitory computer-readable medium of claim 17, wherein the inter-company comparison comprises a quantified benchmark comparing the KPI of a first company of the plurality of companies and the KPI of a second company of the plurality of companies.

20. The non-transitory computer-readable medium of claim 17, wherein the set of asset performance information comprises asset performance information associated with a first location associated with the company and a second location associated with the company, and further comprising generating an intra-company comparison comparing the KPI associated with the first location to the KPI associated with the second location.

21. A method comprising:
determining, by the processing device, at a first time, a baseline value for a key performance indicator (KPI) relating to a company;
receiving, by a processing device, a set of asset performance information relating to at least one target asset associated with the company;
calculating, by the processing device, at a second time, a second value for the KPI in view of the set of asset performance information;
determining, by the processing device, a return on investment metric based on a comparison of the baseline value for the KPI and the second value for the KPI;
generating, by the processing device, a report comprising the return on investment metric.

22. The method of claim 21, further comprising:
receiving, by the processing device, an indication of a target KPI; and
determining, a potential return on investment metric based on a comparison of the target KPI and the second value for the KPI.

23. The method of claim 22, wherein the target KPI is determined based on one or more KPI values associated with one or more other companies.

24. The method of claim 22, wherein the target KPI is determined based on one or more KPI values associated with one or more other assets relating to the company.
